(19) United States
(12) Patent Application Publication
(10) Pub. No.: US 2022/0123346 A1
(43) Pub. Date: Apr. 21, 2022

(54) MULTI-CELL FLOW BATTERY AND FUEL CELL ASSEMBLIES

(71) Applicants: Jonghyun Park, Rolla, MO (US); Hiep Pham, Rolla, MO (US); Ian Wolf, Rolla, MO (US)

(72) Inventors: Jonghyun Park, Rolla, MO (US); Hiep Pham, Rolla, MO (US); Ian Wolf, Rolla, MO (US)

(73) Assignee: The Curators of the University of Missouri, Columbia, MO (US)

(21) Appl. No.: 17/506,123

(22) Filed: Oct. 20, 2021

Related U.S. Application Data
(60) Provisional application No. 63/169,551, filed on Apr. 1, 2021.
(60) Provisional application No. 63/093,849, filed on Oct. 20, 2020.

(51) Int. Cl. H01M 8/2475; H01M 8/00; H01M 8/026

(52) U.S. Cl. CPC H01M 8/2475; H01M 8/026; H01M 8/004

(57) ABSTRACT

A multi-cell electrochemical reaction cell structure for a flow battery or fuel cell having a plurality of cells electrically connected in series or parallel. A first housing has a pair of mating end plates assembled together, each forming a plurality of recesses in which one of the cells is received. One of the end plates has a projection along its perimeter and the other one of the end plates has a groove along its perimeter. The projection is configured to fit within the groove in a mating relationship to seal the housing when the end plates are engaged with each other. A second housing is a tubular shell in which a plurality of tubular flow cell units electrically connected in parallel are housed. Catholyte flows in the tubular flow cell units and anolyte flows in the tubular shell.

### CROSS REFERENCE TO RELATED APPLICATIONS

This application claims the benefit of U.S. Provisional Patent Application No. 63/093,849, filed Oct. 20, 2020, and U.S. Provisional Patent Application No. 63/169,551, filed Apr. 1, 2021, the entire disclosures of which are incorporated by reference for all purposes.

### BACKGROUND

Aspects of the present disclosure relate generally to flow battery and fuel cell technologies.

Conventional flow batteries include a cathode, an anode, a membrane separator, current collectors, gaskets, insulators, and reaction cells within a confined volume, such as within channels of a bipolar plate. All of these components must be carefully compressed between two end plates. The bipolar plate, also called a flow-field plate, distributes an electrolyte solution inside flow battery cells, isolates different cells in multi-cell battery cores, conveys current into and out of cells, and dissipates the stack heat. The main role of the bipolar plate is to deliver reactants to and from porous anode and cathode materials via flow field channels.

Fuels cells are a promising carbon-neutral and sustainable power source for portable, mobile, and stationary applications. In general, a conventional fuel cell comprises an anode, a cathode and an electrolyte. The fuel cell includes first and second housing sections, or end plates, assembled together via a plurality of mechanical fasteners, such as bolts. An anode fuel inlet supplies hydrogen fuel to one electrode (the anode) where it is oxidized to release electrons to the anode and hydrogen ions to an electrolyte. A cathode fuel inlet supplies oxidant (typically air or oxygen) to the other electrode (the cathode) where electrons from the cathode combine with the oxygen and the hydrogen ions in the electrolyte to produce water.

Fuel cells convert chemical energy generated from oxidation of hydrogen into electric energy. In operation, the cell processes a hydrocarbon fuel source to produce the hydrogen. Liquid hydrocarbon fuel sources offer high energy densities and the ability to be readily stored and transported. Because fuel cells have a higher efficiency compared to internal combustion engines, and are substantially free from emission of pollutants, they have garnered attention as an alternative energy technology.

In the conventional fuel cell, the housing contains flat flow field channel blocks or plates designed to provide an adequate amount of a reactant (hydrogen or oxygen) to a flat membrane electrode assembly (MEA) sandwiched between the plates. Each MEA in a stack is sandwiched between two flow field plates to separate it from neighboring cells, similar to flow batteries. The flow field plates, also referred to as bipolar plates, are typically formed of metal, graphite, or a carbon composite to permit good transfer of electrons between the anode and the cathode. Gaskets provide a seal around the MEA to help prevent leaks between the MEA and the flow field plates.

In conventional stacked structures for both fuel cells and flow cells, components such as the electrodes, bipolar plates, and gaskets are exposed at the edges, causing significant challenges with electrolyte leakage and subsequent performance loss. Stacking of cells yields higher voltages but exacerbates leakage issues, as the channels to deliver the electrolyte to each cell are also exposed. To address these challenges, work has been done to develop a better seal between components, such as the addition of rubber seals and polymer fittings to a unit cell design, which can allow higher compression between the components. Nevertheless, leakage remains a significant challenge because cell components remain exposed and the end plates are graphite-based.

### SUMMARY

Aspects of the present disclosure focus on developing well performing redox flow batteries and fuel cells comprising multiple high voltage cells to increase their energy output. The disclosed multi-cell structure addresses the issues in stacking cells by embedding all components within the end plates and eliminating the need for several gasket components thus protecting the structure, lowering the effective weight of the cells, and eliminating safety concerns. Aspects of the present disclosure further incorporate multiple cells into a single design to achieve a high voltage redox flow battery or fuel cell.

In an aspect, a multi-stack fuel cell comprises a plurality of electrochemical reaction cells electrically connected in series. The reaction cells each comprise an anode electrode and a cathode electrode. The fuel cell also comprises a housing having a pair of mating end plates assembled together. The end plates each have a recess formed in an inner surface thereof in which the plurality of reaction cells are received. The housing also contains an electrolyte fluid in contact with the electrodes.

In another aspect, a multi-stack flow battery comprises a plurality of flow cell units electrically connected in series and a housing. The housing has a pair of mating end plates assembled together, each of which has a plurality of recesses formed in an inner surface thereof. The recesses each receive one of the flow cell units. One of the end plates has a projection along a perimeter of each of the recesses and the other one of the end plates has a groove along a perimeter of each of the recesses. The projection is configured to fit within the groove in a mating relationship to seal the housing when the end plates are engaged with each other.

In another aspect, a multi-stack electrochemical reaction cell structure for a flow battery or fuel cell has a plurality of cells electrically connected in series and in fluid communication with each other. The cells each comprise an anode electrode and a cathode electrode and an electrolyte fluid in contact with the electrodes. A housing has a pair of mating end plates assembled together, each forming a plurality of recesses in which one of the cells is received. One of the end plates has a projection along a perimeter of each of the recesses and the other one of the end plates has a groove along a perimeter of each of the recesses. The projection is configured to fit within the groove in a mating relationship to seal the housing when the end plates are engaged with each other.

In yet another aspect, a multi-stack electrochemical reaction cell structure includes a plurality of tubular cells electrically connected in parallel and in fluid communication with each other. Each cell has an electrode and a corresponding membrane. The cell structure also includes a tubular housing in which the tubular cells are positioned, a catholyte fluid contained within each of the tubular cells and in contact with the electrode thereof, and an anolyte fluid contained within the housing and in contact with the catholyte fluid at the membrane of each of the tubular cells.

Other objects and features will be in part apparent and in part pointed out hereinafter.

### BRIEF DESCRIPTION OF THE DRAWINGS

FIGS. 1A and 1B are schematic diagrams of a male end plate and a female end plate, respectively, of an embedded, multi-cell flow battery according to an embodiment.

FIGS. 2A and 2B are schematic diagrams of an anode side and a cathode side, respectively, of an embedded stacked fuel cell according to an embodiment.

FIG. 2C illustrates an exploded assembly of the embedded stacked fuel cell of FIGS. 2A and 2B, including corrugated electrodes.

FIG. 3 illustrates a wrapped catholyte tubing structure having flow and active areas for an embedded, parallel stacked design according to an embodiment.

Corresponding reference characters indicate corresponding parts throughout the drawings.

### DETAILED DESCRIPTION

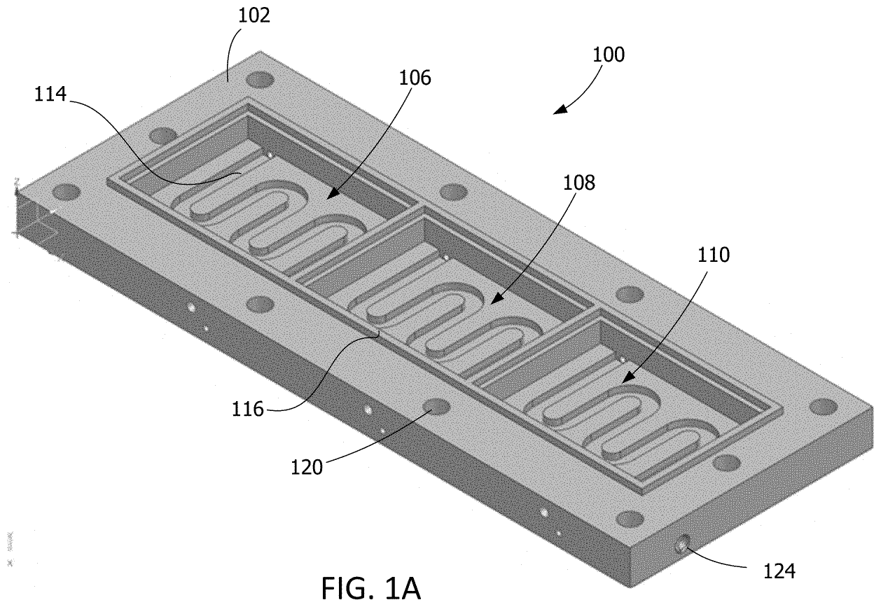

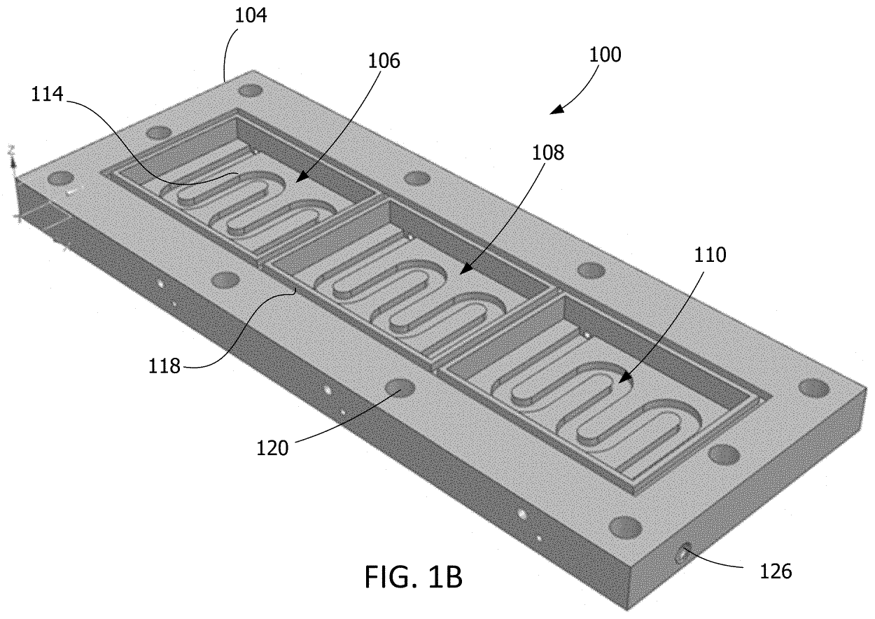

Referring to the drawings, FIGS. 1A and 1B show a multi-cell embedded structure for a flow battery 100. The flow battery design, which resembles a plate heat exchanger in accordance with embodiments of the present disclosure, enables serial connection of multiple cells to increase the voltage of the flow battery 100 and thus increase its power. A first end plate 102 mates with a second end plate 104 to form a housing. In the illustrated embodiment, each of the end plates 102, 104 features three compartments 106, 108, 110 formed in an inner surface of the end plates and defined by a plurality of recess walls.

When end plates 102, 104 are assembled together, each of the compartments 106, 108, 110 defines one reaction cell of battery 100. Within each of the compartments 106, 108, 110, a flow channel 114 is etched into end plate 102 in, for example, a serpentine pattern. Similarly, the end plate 104 features three corresponding compartments 106, 108, 110 etched with the corresponding flow channel 114. It is to be understood that the design of flow battery 100 could be scaled to accommodate any number of individual cells. In addition, it is to be understood that flow channel 114 may be formed in other patterns and have other dimensions within the scope of the present invention.

The first end plate 102 and the second end plate 104 are configured to contain and protect the components of multiple reaction flow cells corresponding to the compartments 106, 108, 110 when the end plates are mated together to form a housing. The end plates 102, 104 may be manufactured from any rigid material compatible with the electrolytes. For example, the rigidity of first end plate 102 and second end plate 104 obviates the need for external or separate end plates and the compatibility with the electrolytes obviates the need for insulators. In an embodiment, end plates 102, 104 are manufactured from a thermoplastic, such as polyvinyl chloride (PVC). Exemplary advantages of PVC include light weight, good mechanical strength, impermeability, and resistance to weathering, chemical rotting, and corrosion. Furthermore, PVC can be cut, shaped, and joined in a variety of configurations.

When assembled, a male tongue 116 of end plate 102 mates with a female groove 118 of end plate 104 to form a seal. In an embodiment, end plates 102, 104 are bolted together through plurality of bolt holes 120 distributed about an outer margin of the end plates to ensure sealing during cell operation. In an embodiment, mechanical fasteners such as bolts are configured to mechanically join first end plate 102 and second end plate 104 into a single housing assembly. Although embodiments described herein utilize bolt fasteners, one of ordinary skill in the art will understand that other mechanical fasteners are within the scope of the present disclosure. Exemplary mechanical fasteners include, but are not limited to, clamps, clips, pins, rivets, screws, staples, and the like. Moreover, one of ordinary skill in the art will understand that end plates 102, 104 may be mechanically joined by alternative means. Exemplary means for joining the end plates include, but are not limited to, crimping, welding, soldering, brazing, taping, gluing (or other adhesives), cementing, and the like. Additionally or alternatively, first end plate 102 and second end plate 104 may be joined with by magnetic force, vacuum force (e.g., suction cups, etc.), friction force, and the like. In the various embodiments, the male tongue 116 of end plate 102 mates with the female groove 118 of end plate 104 to form a seal.

The reaction flow cell contained by each compartment 106, 108, 110 is configured to provide an environment through which electrolyte fluids flow, resulting in ion exchange that provides a flow of electric current. Each cell of battery 100 has at least a pair of electrodes separated by a membrane positioned within a recess defined by each compartment 106, 108, 110. In an embodiment, conductors (not shown) extend from the reaction flow cells. The conductors are configured to carry electrical current from the reaction flow cells to electrical contacts connected to an electrical load (e.g., of a transport system, etc.).

A tank or reservoir (not shown) supplies an anolyte to compartments 106, 108, 110 of end plate 102 via a flow inlet 124. Similarly, another tank or reservoir (not shown) supplies a catholyte to compartments 106, 108, 110 of end plate 104 via a flow inlet 126. The inlets 124, 126 are configured for fluidly communicating electrolyte fluids from corresponding tanks to the flow cells. An exemplary anolyte includes vanadium electrolyte solution (V+2, V+3) and an exemplary catholyte includes vanadium electrolyte solution (V+5, V+4). The flow inlets 124, 126 are internal channels within end plates 102, 104, respectively, configured to provide electrolyte to each compartment 106, 108, 110 when the end plates are assembled together. Supply tubes for inlets 124, 126 may be comprised of any polymer compatible with the electrolytes, such as PVC, polytetrafluoroethylene (PTFE), high-density polyethylene (HDPE), low-density polyethylene (LDPE), and the like. As described above, each compartment 106, 108, 110 contains the flow channel 114 (e.g., an etched serpentine flow pattern) and houses the components of a flow cell unit of battery 100.

In an embodiment, current collectors composed of stainless steel, graphite or carbon materials, or a mix of these materials, having the same serpentine flow pattern as flow channel 114 of end plates 102, 104, are placed into each compartment 106, 108, 110 and connected together in series by externally connecting the electrodes. Preferably, the serpentine flow pattern etched into end plates 102, 104 is uninterrupted by the separating dividers between compartment 106 and compartment 108 and between compartment 108 and compartment 110. Using the hybrid alkaline Zn—I2 system as a demonstration, the open circuit voltage (OCV) of a test battery increased from a single cell voltage of 1.7 V to a multi-cell voltage of 4.2 V.

Aspects of a reaction flow cell for a battery are further described herein and in U.S. Pat. Nos. 10,367,221 and 11,031,619, the entire disclosures of which are expressly incorporated herein by reference, including the contents and teachings of any references contained therein.

Referring further to FIGS. 1A and 1B, flow battery 100 provides numerous advantages of conventional cell structures, which require numerous components such as porous graphite end plates having etched flow channels, two electrodes (the cathode and anode), a separator, current collectors, and gaskets and insulators. Furthermore, these numerous components of conventional cell structures are exposed from the end plates and require high compression and specific material selection to achieve both mechanical integrity and chemical resistance in order to operate properly. The complex design of conventional cells raises issues related to high weight (lowering gravimetric energy density), high space occupation (lowering volumetric energy density) and electrolyte leakage (lowering safety). Further, the stacking of cells compounds these issues. Aspects of the present disclosure overcome these challenges of conventional cell structures by embedding all components within end plates 102, 104, which has been etched with flow channels 114, and by incorporating multiple cells in a single assembly. In this manner, the number of components needed to stack individual cells and increase voltage is relatively small and advantageously uses a single set of current collectors for each cell to be added.

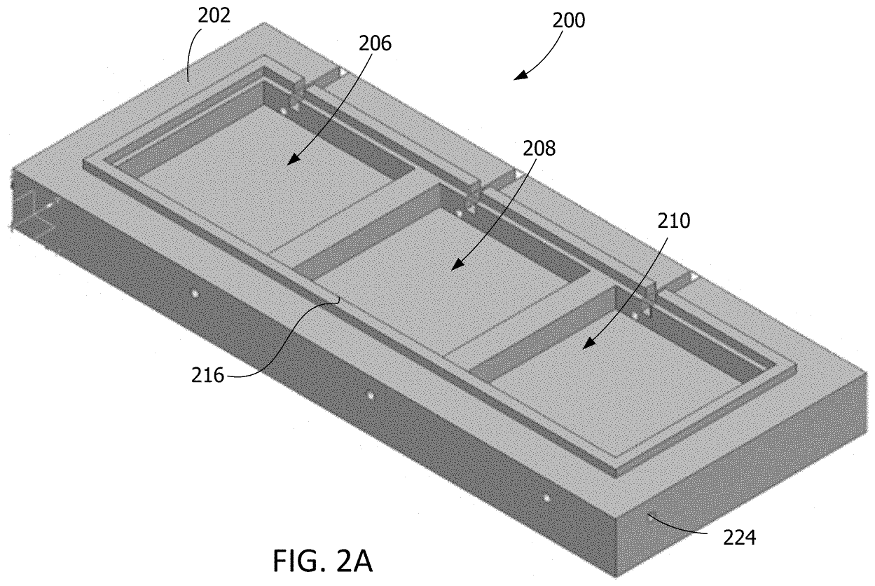

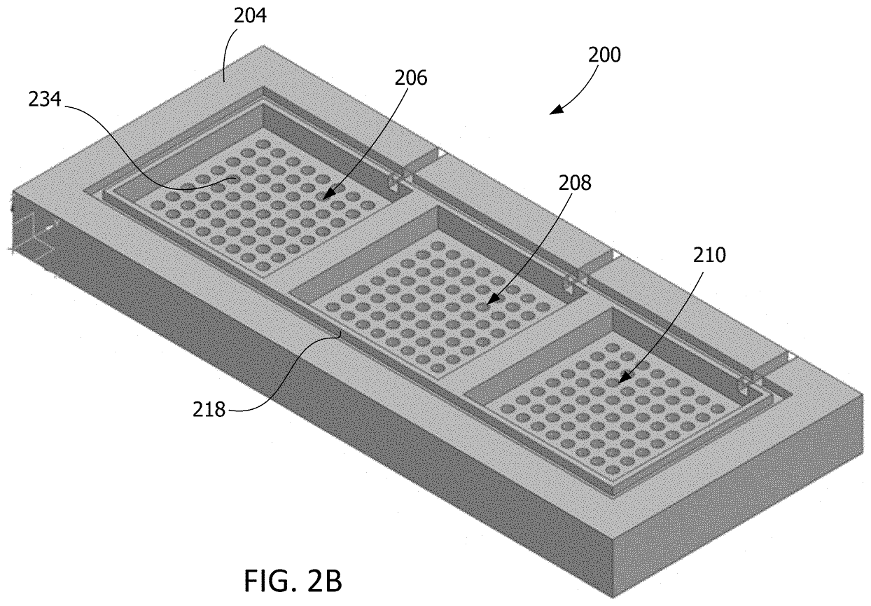

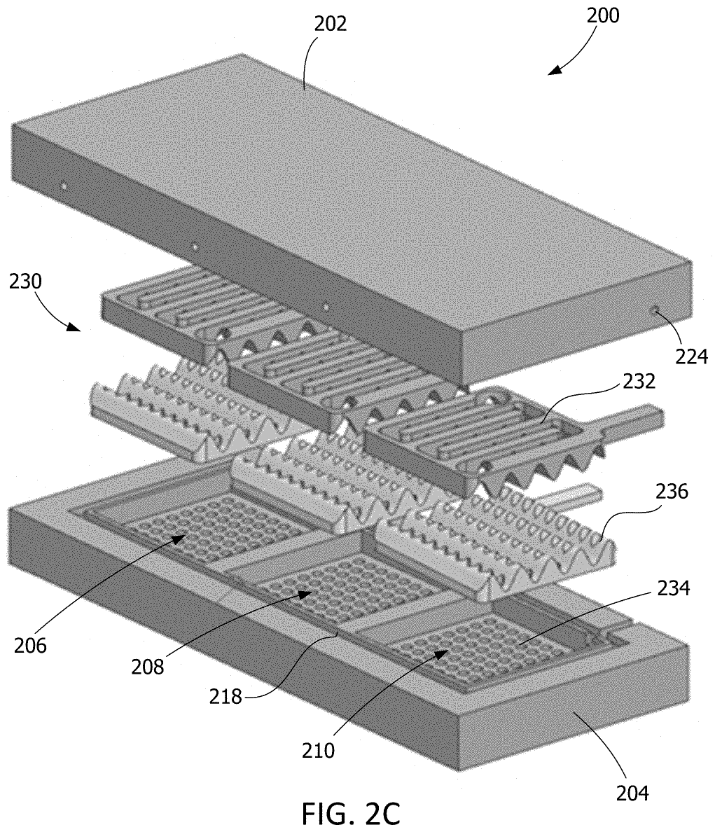

FIGS. 2A and 2B show a design for stacked embedded structures for a fuel cell 200, which resembles a plate heat exchanger in accordance with embodiments of the present disclosure. In FIGS. 2A and 2B, an embedded, series stacked design that can accommodate three fuel cell units is shown. Similar to the stacked design of flow battery 100, the stacked fuel cell 200 comprises a first end plate 202 that mates with a second end plate 204 to form a housing. In the illustrated embodiment, each of the end plates 202, 204 features three compartments 206, 208, 210 formed in an inner surface of the end plates and defined by a plurality of recess walls. When end plates 202, 204 are assembled together, each of the compartments 206, 208, 210 defines one fuel cell unit of fuel cell 200. It is to be understood that the design of fuel cell 200 could be scaled to accommodate any number of individual cells.

The first end plate 202 and the second end plate 204 are configured to contain and protect the components of multiple fuel cell units corresponding to the compartments 206, 208, 210 when the end plates are mated together to form a housing. When assembled, a male tongue 216 of end plate 202 mates with a female groove 218 of end plate 204 to form an impermeable seal. It is to be understood that end plates 202, 204 are configured to be joined together by various means without deviating from the present invention. A fuel inlet 224 to a manifold on the anode side delivers the fuel to each cell compartment 206, 208, 210. The cathode side contains holes to allow airflow for proper fuel cell operation.

FIG. 2C illustrates fuel cell 200 embodying further aspects of the present disclosure. When assembled, the components of the multiple fuel cell units of fuel cell 200 are housed within compartments 206, 208, 210. In this manner, the end plates 202, 204 obviate the need for gaskets. Referring further to FIG. 2C, fuel cell 200 includes a fuel cell membrane electrode assembly (MEA) structure 230 housed in each of the compartments 206, 208, 210 formed in end plates 202, 204. The MEA 230 includes an anode channel 232 and a cathode channel 234 across which an electrical load may be connected. In the illustrated embodiment, the cathode channel 234 is preferably formed in end plate 204. The MEA 230 further includes a membrane 236 sandwiched between anode channel 232 and cathode channel 234.

In the illustrated embodiment, the structures of MEA 230 have a matching corrugated shape, which increases the number of sites for the reaction to occur and thus increases the voltage relative to planar electrodes. Aspects of a fuel cell having a corrugated membrane electrode assembly are further described herein and in U.S. patent application Ser. No. 16/993,397, the entire disclosure of which is expressly incorporated herein by reference, including the contents and teachings of any references contained therein.

Although the cross-sections of the reaction flow cells of FIGS. 1A and 1B and the fuel cell units of FIGS. 2A-2C described herein are substantially rectangular, one having ordinary skill in the art will understand that they may have different cross-sectional shapes, such as substantially square, circular, elliptical, triangular, hexagonal, octagonal, U-shaped, and the like.

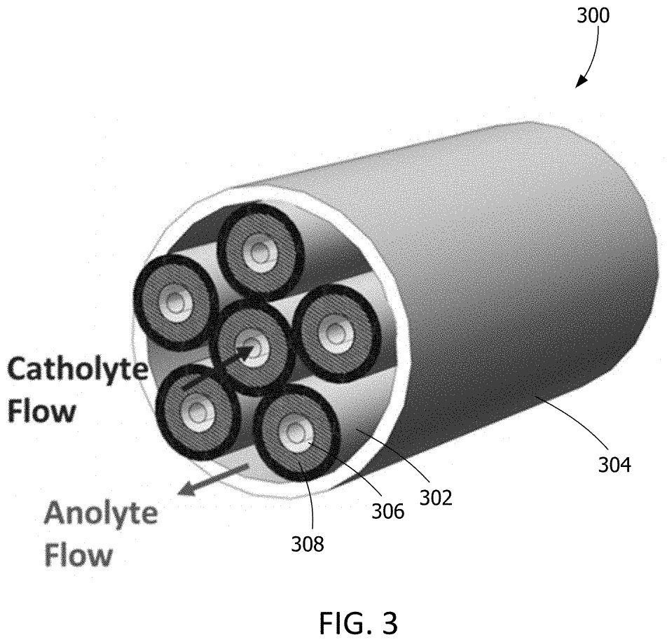

FIG. 3 illustrates aspects of an embedded structure stacked in parallel. In this instance, a flow battery 300 resembles a tube-in-shell heat exchanger, in accordance with an embodiment of the invention. In FIG. 3, a cross-sectional view shows multiple tubes 302 housed within a shell 304. Catholyte flows as shown through the tubes 302 and anolyte flows through the shell 304 around tubes 302. In an embodiment, catholyte tubes 302 have holes located radially along the length of each tube to permit transfer of the catholyte within the tubes through a flow cell carbon cloth electrode 306 and a membrane 308. As the catholyte flows through each tube 302, the anolyte is delivered through the shell 304 and meets the catholyte at the boundary of the carbon cloth electrode 306 and membrane 308 to allow the reaction to occur. Because there are numerous tubes which deliver the catholyte, the active surface area can be increased substantially compared to the conventional redox flow battery electrode of the same size, thereby increasing the power density.

To solve the challenges presented by known designs, aspects of the present disclosure utilize an embedded structure, wherein all of the components of the fuel cell or flow battery, including electrolyte flow channels, are embedded and then stacked, either in series or parallel configurations. These new embedded structures bear resemblance to plate heat exchangers when stacked in series and a tube-in-shell heat exchanger when stacked in parallel. In series, the embedded system encapsulates all components of the fuel or flow cell in a “pocket” structure which serves as the end plates. The pocket structure, itself, replaces the conventionally used graphite end plates with PVC which is impermeable, resistant to chemical corrosion, lightweight, more facile to machine, and cost-effective. The end plates are mated together by a male tongue/female groove that lies between the pocket and the bolt holes which hold the end plates together. The electrolyte/fuel is delivered through a manifold that lies within the end plate. By embedding the components and electrolyte/fuel delivery channels and implementing a male tongue/female groove, the leakage issue is eliminated and stacked cells which can achieve high voltage and performance are enabled.

In parallel, the embedded system encapsulates the components as numerous inner tubes wrapped by the cell components and an overall larger shell. The catholyte is delivered via the inner tubes, which are wrapped with the cell components, such as a porous current collector, membrane and electrodes. The numerous inner tubes are wrapped by a shell, in which anolyte is flowed through and makes the required contact with the catholyte at the membrane to facilitate the power and energy generation. This design is analogous to a “tube-in-shell” type heat exchanger and permits a very high surface area due to numerous tubes which comprise the design, thereby substantially increasing the power density.

In an aspect, a new cell structure design for redox flow batteries, an energy storage technology, overcomes the limitations of conventional cell structure designs. Generally, a typical redox flow battery cell design is composed of several exposed components which have issues such as high weight, high space utilization, and electrolyte leakage. As numerous cells are stacked together to increase the voltage output, these issues are exacerbated. Aspects of the present disclosure feature a pocket-like design that incorporates multiple cells into one assembly to improve voltage and energy output. Unlike conventional designs, which stack individual cells together, embodiments of the invention connect cells in series internally into end plates with etched flow channels, eliminates several gasket components, and effectively lowers the overall weight of the battery.

In another aspect, high voltage fuel cells and redox flow cells are enabled by multiple cell stacking contained within one embedded structure, wherein all of the components and electrolyte/fuel delivery channels are embedded in a pocket structure composed of PVC end plates.

Further aspects of the present disclosure enable high voltage fuel cells and redox flow cells by encapsulating, or embedding, the components of the systems into a closed format and stacking them in series or parallel. A multi-cell structure embodying aspects of the invention bears resemblance to various heat exchanger designs. In series, multiple cell stacking contained within one embedded structure, wherein all of the components and electrolyte/fuel delivery channels are embedded in a pocket structure composed of PVC end plates. In parallel, the system comprises numerous inner tubes flowing the catholyte that are wrapped with by the flow cell components (carbon cloth electrodes, membrane, etc.) and a flow of the anolyte in the outer shell.

It is to be understood that aspects of the present disclosure are applicable to other types of flow batteries and fuel cells and to reaction cells generally.

Aspects of the present disclosure address the issues in stacking cells by removing the need for several gasket components and by embedding all components aside from the end plates, protecting the structure, lowering the effective weight of the cells, and eliminating safety concerns. Furthermore, the present design incorporates multiple cells into a single design to achieve high voltages.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A multi-cell fuel cell comprising:
a housing comprising a pair of mating end plates assembled together, the end plates each having a plurality of recesses formed in an inner surface thereof, the recesses defining a plurality of corresponding compartments when the end plates are assembled together;
a plurality of electrochemical reaction cells electrically connected in series, the reaction cells each received in one of the compartments and comprising an anode electrode and a cathode electrode; and
an electrolyte fluid contained within the housing and in contact with the electrodes.

2. The fuel cell of claim 1, wherein the anode electrode and the cathode electrode each have a corrugated shape, the corrugated shape comprising alternating peaks and valleys, the peaks and valleys of the anode electrode matching with corresponding peaks and valleys of the cathode electrode in a mating relationship.

3. The fuel cell of claim 1, wherein the anode electrode of each of the reaction cells comprises a flow channel plate having a flow channel distributed throughout in a serpentine configuration.

4. The fuel cell of claim 1, wherein each of the end plates includes a plurality of recess walls defining the recesses formed in the inner surface thereof, the recess walls configured to contain the electrolyte fluid.

5. The fuel cell of claim 1, wherein one of the end plates includes a projection along an outer margin thereof and the other one of the end plates includes a groove along an outer margin thereof, the projection configured to fit within the groove in a mating relationship to seal the housing when the end plates are engaged with each other.

6. The fuel cell of claim 5, wherein the projection and the groove are both continuous.

7. A multi-cell electrochemical reaction cell assembly comprising:
a housing comprising a pair of mating end plates assembled together, the end plates each having a plurality of recesses formed in an inner surface thereof, the recesses each receiving one of the cells therein;
a plurality of cells electrically connected in series and in fluid communication with each other, the cells each received in one of the compartments and comprising an anode electrode and a cathode electrode; and
an electrolyte fluid contained within the housing and in contact with the electrodes;
wherein one of the end plates includes a projection along a perimeter of each of the recesses formed therein and the other one of the end plates includes a groove along a perimeter of each of the recesses formed therein, the projection configured to fit within the groove in a mating relationship to seal the housing when the end plates are engaged with each other.

8. The multi-cell electrochemical reaction cell assembly of claim 7, wherein the projection and the groove are both continuous.

9. The multi-cell electrochemical reaction cell assembly of claim 7, wherein the flow cell units each comprises a flow channel plate having a flow channel distributed throughout, the flow channel configured to convey an electrolyte fluid.

10. The multi-cell electrochemical reaction cell assembly of claim 9, wherein the flow channel has a serpentine configuration.

11. The multi-cell electrochemical reaction cell assembly of claim 9, wherein the flow channel is etched into the inner surface of one of the end plates within the recesses.

12. The multi-cell electrochemical reaction cell assembly of claim 7, wherein each of the end plates includes a plurality of recess walls defining the recesses formed in the inner surface thereof, the recess walls configured to contain the electrolyte fluid.

13. The multi-cell electrochemical reaction cell assembly of claim 7, wherein the assembly comprises a flow battery.

14. The multi-cell electrochemical reaction cell assembly of claim 7, wherein the assembly comprises a fuel cell.

15. A multi-cell electrochemical reaction cell assembly comprising:
a tubular housing;
a plurality of tubular cell units positioned within the housing, the cell units electrically connected in parallel and in fluid communication with each other, the tubular cell units each comprising an electrode and a corresponding membrane;
a catholyte fluid contained within each of the tubular cell units and in contact with the electrode thereof; and
an anolyte fluid contained within the tubular housing and in contact with the catholyte fluid at the membrane of each of the tubular cell units.

16. The multi-cell electrochemical reaction cell assembly of claim 15, wherein the catholyte fluid flows through the tubular cell units and the anolyte flows within the tubular housing around the tubular cell units.

17. The multi-cell electrochemical reaction cell assembly of claim 15, wherein the tubular cell units each comprise a flow cell carbon cloth electrode and membrane wrapped thereon.

18. The multi-cell electrochemical reaction cell assembly of claim 17, wherein the tubular cell units each include a plurality of holes located radially along a length thereof through which the catholyte is transferred to the flow cell carbon cloth electrode and membrane.

19. The multi-cell electrochemical reaction cell assembly of claim 15, wherein the assembly comprises a flow battery.

20. The multi-cell electrochemical reaction cell assembly of claim 15, wherein the assembly comprises a fuel cell.
